(19) United States
(12) Patent Application Publication
(10) Pub. No.: US 2010/0213990 A1
(43) Pub. Date: Aug. 26, 2010

(54) HIGH FREQUENCY POWER SWITCHING CIRCUIT WITH ADJUSTABLE DRIVE CURRENT

(75) Inventors: Jian YANG, Beijing (CN); Wei Mao, Beijing (CN); Chuanzheng Wang, Beijing (CN); Hongwei Zhao, Beijing (CN); Jianhua Zheng, Beijing (CN)

Correspondence Address: ONDA TECHNO Intl. Patent Attys., 12-1 Omiya-cho 2-chome, Gifu City, 500-8731, JP

(73) Assignee: FREESCALE SEMICONDUCTOR, INC, Austin, TX (US)

(21) Appl. No.: 12/701,604

(22) Filed: Feb. 8, 2010

(30) Foreign Application Priority Data
Feb. 24, 2009 (CN) 200910007747

(51) Int. Cl. G05F 1/10

(52) U.S. Cl. 327/109

(57) ABSTRACT

A MOSFET pre-driver circuit with highly adjustable drive current for a high frequency switching power MOSFET circuit decreases the peak of the drive current and power loss of the pre-driver while maintaining power loss of the power stage so that total power loss is decreased and circuit efficiency is increased. A resistor arranged in series with a source of the MOSFET of the pre-driver circuit is provided to adjust the drive current.

### BACKGROUND OF THE INVENTION

The invention relates generally to high frequency power switching circuits and more particularly to a highly adjustable drive technique for high frequency power switching circuits.

Power switching circuits, such as the power MOSFET and the insulated-gate bipolar transistor (IGBT), are commonly used in a variety of switching applications. However, when used in high frequency applications, the power switching circuits introduce a large amount of substrate noise and power/ground bounce. This leads to poor electro-magnetic compatibility (EMC). This can also degrade performance of sensitive analog blocks and increase electro-magnetic interference (EMI) within the chip.

Dynamic switching loss of the power MOSFET also increases as the working frequency of the switching circuit increases. For relatively high frequency, i.e. for frequencies greater than 1 MHZ, power switching circuits that are integrated together in the same chip, the switching speed of the power devices are all relatively extremely fast, i.e. approximately 10 ns. In addition, high di/dt also introduces and further contributes to the large power/ground bounce. As a result, switching loss of the high frequency power switching device increases further and inductive noise is injected into the substrate, which may adversely impact the performance of other devices resident on the chip. Since the circuit work frequency is very high and the dead-time of the above high frequency circuits is very short (˜10 ns), traditional methods can not meet such short dead-time request. Traditional methods are therefore not suitable in such applications to optimize the trade off among power loss, circuit efficiency, EMC and substrate noise.

Therefore, there is a need for a highly adjustable drive technique for high frequency power switching circuits that addresses the above problems. In particular, there is a need to reduce substrate noise, and improve EMC while improving the efficiency of a high frequency power switching circuit.

### BRIEF DESCRIPTION OF THE DRAWINGS

In order that embodiments of the invention may be fully and more clearly understood by way of non-limitative examples, the following description is taken in conjunction with the accompanying drawings in which like reference numerals designate similar or corresponding elements, regions and portions, and in which:

FIG. 1 is a schematic circuit diagram that illustrates an adjustable drive technique for a high frequency power switching circuit in accordance with an embodiment of the invention;

FIG. 2 is a graph of simulated substrate noise and efficiency of the circuit of FIG. 1;

FIG. 3 is a graph charting the simulated drive current, power supply voltage and gate voltage at PM1 of the circuit of FIG. 1;

FIG. 4 is a schematic circuit diagram of a comparative circuit to show the advantages achieved with the circuit of FIG. 1 in accordance with an embodiment of the invention;

FIG. 5 is a graph of simulated substrate noise and efficiency of the circuit of FIG. 1 verses the comparative circuit of FIG. 4;

FIG. 6 is graph charting the simulated drive current, power supply voltage and gate voltage at PM1 of the comparative circuit of FIG. 4; and

FIG. 7 is a graph of measured substrate noise and efficiency of the circuit of FIG.1.

### DETAILED DESCRIPTION OF THE INVENTION

An aspect of the invention is a pre-driver circuit for driving a power switching circuit, the power switching circuit having a power device of a power stage of the power switching circuit. The pre-driver circuit includes a MOSFET having a source and a drain to drive with a drive current power devices of the power stage of the power switching device; and a resistor in series with the source of the MOSFET to adjust the drive current.

In an embodiment of the invention, the resistance of the resistor is selected to have a voltage across the resistor with the presence of the drive current to reduce the effective gate-source voltage (Vgs) and the drain-source voltage (Vds) of the MOSFET to adjust the drive current. The pre-driver circuit may comprise four MOSFET and a resistor in series with the source of the MOSFET to adjust the drive current, and the four MOSFET may comprise two NMOS and two PMOS. The pre-driver circuit may be part of a buck converter.

An aspect of the invention is a power switching circuit comprising a pre-driver circuit for driving the power switching circuit and a power stage having a power device. The pre-driver circuit comprises a MOSFET having a source and a drain to drive with a drive current power devices of the power stage of the power switching device; and a resistor in series with the source of the MOSFET to adjust the drive current.

An aspect of the invention is a method of driving a power switching circuit with a pre-driver circuit. The power switching circuit has a power device of a power stage of the power switching circuit, and the pre-driver circuit drives with a drive current the power device of the power stage of the power switching device. The method includes providing a MOSFET in the pre-driver circuit having a source and a drain to drive with a drive current power devices of the power stage of the power switching device; and adjusting the drive current of the MOSFET by selecting a resistor arranged in series with the source of the MOSFET to adjust the drive current.

A pre-driver circuit and technique with highly adjustable drive current for high frequency switching power MOSFET circuit is provided by selecting a resistor arranged in series with a source of the MOSFET of the pre-driver circuit to adjust the drive current. The pre-driver circuit is designed to minimize peak of the drive current, and minimize power loss of the pre-driver while maintaining power loss of the power stage. Embodiments of the invention decrease total power loss and increase circuit efficiency. In view of conventional circuit designs, embodiments of the invention have a circuit configuration that reduces substrate noise and improves EMC while improving efficiency of the circuit.

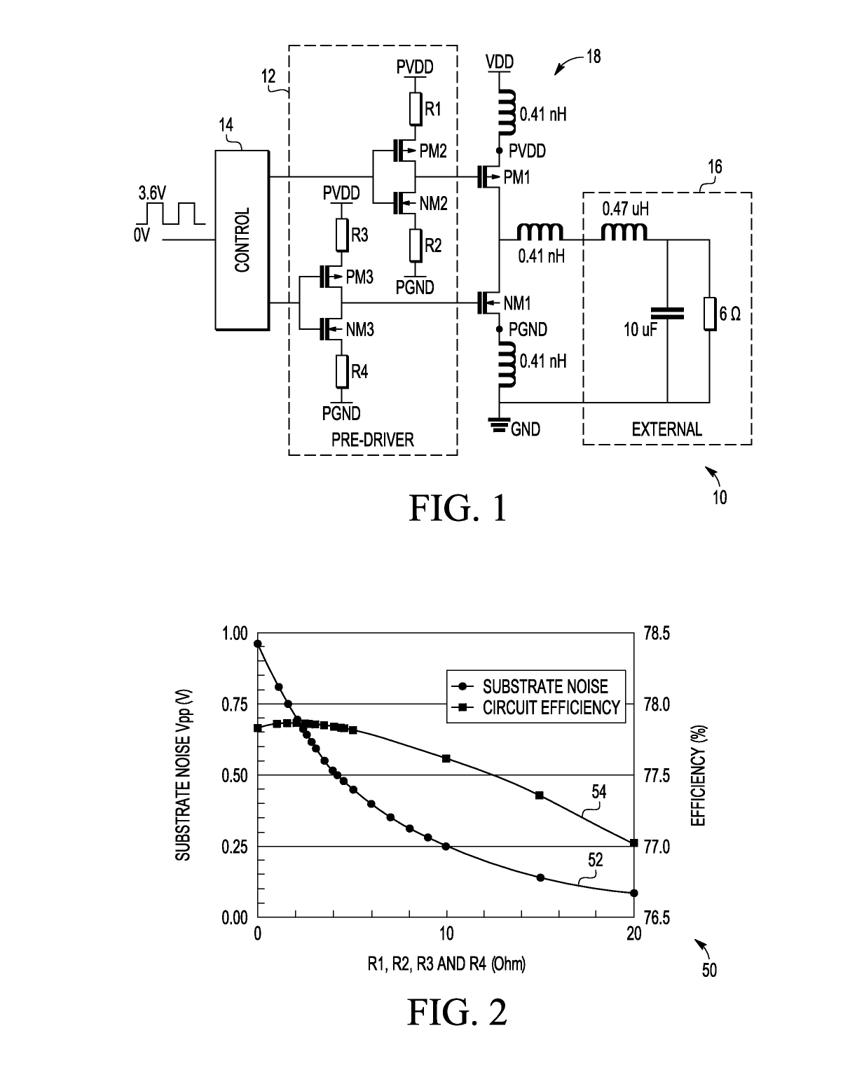

FIG. 1 shows a schematic diagram of a high frequency switching circuit 10 that provides a highly adjustable drive technique for high frequency power switching circuits in accordance with an embodiment of the invention. With reference to FIG. 1, the circuit 10 includes a pre-driver 12, a control block 14, external components 16, and a power stage 18.

The pre-driver 12 includes a plurality of transistors and a corresponding plurality of resistors. More particularly, in the embodiment shown, there are four MOSFETs PM2, NM2, PM3 and NM4 and four resistors R1-R4. The transistors are paired as PM2 and NM2, and PM3 and NM3; meaning the gate terminals and the drain terminals of the paired transistors are connected together, as shown. Each of the transistors PM2, NM2, PM3 and NM4 has one of the resistors R1-R3, respectively, connected in series with a source terminal thereof. Each of the transistor pairs PM2, NM2, and PM3, NM4 also receives a control signal from the control block at the respective gate terminals thereof.

The power stage 18 includes two MOSFETs PM1 and PM2 that are connected in series between a high voltage source (VDD) and ground. A first inductor is connected between the source of PM1 and VDD, and a second inductor is connected between the source of NM1 and ground. The gates of the power transistors PM1 and NM1 are connected to the drains of the transistor pairs of the pre-driver circuit 12. That is, the drains of PM2 and NM2 are connected to the gate of PM1, while the drains of PM3 and NM3 are connected to the gate of NM1.

The configuration of the resistors R1-R4 allows the drive current of the pre-driver 12 to be readily adjusted. That is, the resistors R1 to R4 allow the drive capability of PM2, PM3, NM2, and NM3 to be adjusted.

The values of resistors R1, R2, R3 and R4 depends on the actual design and specific application and may be the same or different from each other. When the drive current is large, voltage across the resistors is large. The effective gate-source voltage (Vgs) and drain-source voltage (Vds) of PM2, PM3, NM2, and NM3 can be decreased, so that the drive current decreases. When the drive current is small, the effective Vgs and Vds of the pre-driver 12 remains substantially constant and does not change. Similarly, the drive current also remains constant and almost unchanged. The extent of reduction of the drive current is larger for higher drive current during switching on and off, but is reduced for smaller drive current as desired.

The circuit 10 can lower the peak of the drive current yet maintain enough drive capability before fully turning on/off the driven power devices (PM1, NM1). The circuit 10 also has decreased overshoot of power/ground bounce and substrate noise without substantially effecting circuit efficiency.

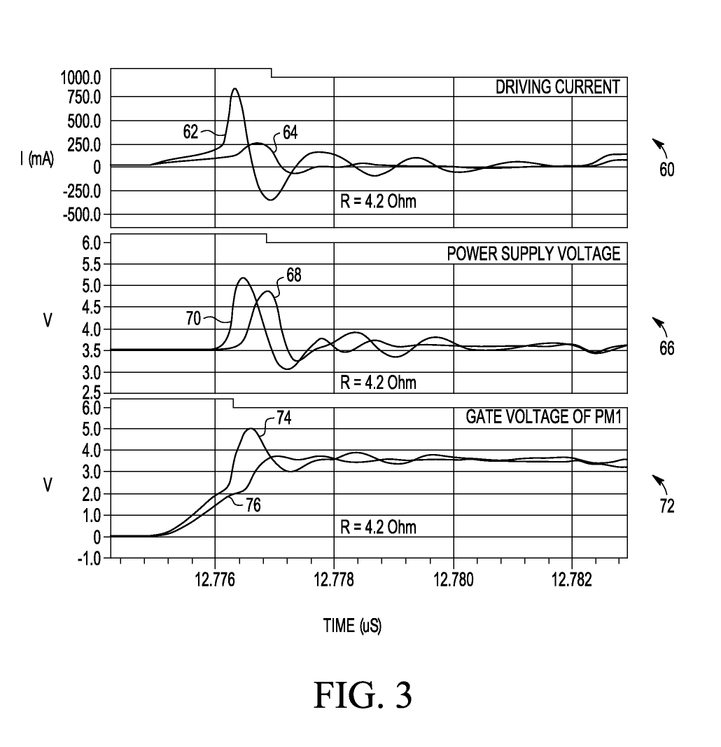

FIG. 2 is a graph 50 of simulated substrate noise and efficiency of the circuit 10 of FIG. 1 in accordance with an embodiment of the invention. FIG. 3 shows graphs charting the simulated drive current 60, power supply voltage 66 and gate voltage at PM1 72 of the circuit 10 of FIG. 1 in accordance with an embodiment of the invention. In the graph 50 of FIG. 2 the substrate noise is shown by line 52 and the circuit efficiency is shown by line 54. Since the silicon area was limited during experimentation, which limited the actual size of the power device to about 75% smaller than usual, the efficiency is shown as being less than 80% in FIG. 2. The efficiency is higher and closer to 90% on full size power devices. In the graphs shown in FIG. 3, the results show different circuit behavior for different resistor values, where the resistor is as original (R=0.0 Ohm for original design without R1 to R4) and where the resistor is R=4.2 Ohm. The value of resistors R1 to R4 depends on the real design and may be different each other. Specifically, the behavior of the circuit 10 of FIG. 1 when the resistor is original (R=0.0 Ohm) is shown by lines 62, 70, 74 for the drive current 60, power supply voltage 66, and the gate voltage of PM1 72, respectively. The behavior of the circuit 10 of FIG. 1 when the resistor is 4.2 Ohms is shown by lines 64, 68, 76 for the drive current 60, power supply voltage 66, and the gate voltage of PM1 73, respectively.

With reference to the graphs shown in FIGS. 2 and 3, it can be seen that the substrate noise is decreased with an increase in R1 to R4, and circuit efficiency is almost unchanged in a certain resistance range. Additionally, peak of drive current decreases, resulting in the decrease of the overshoots of power supply and gate signal.

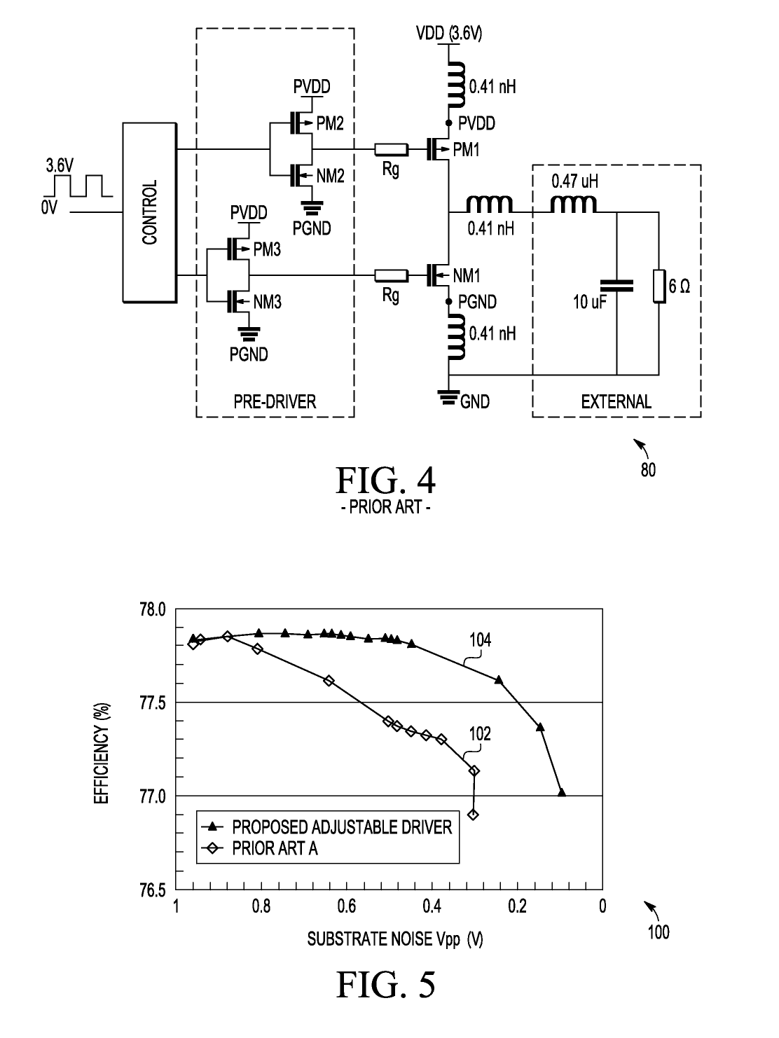

FIG. 4 is a schematic diagram of a comparative circuit 80 for illustrating, for sake of more clearly, the advantages achieved with the circuit 10 of FIG. 1 in accordance with an embodiment of the invention. A circuit like the circuit 80 is described in Chokhawala, Rahul S., “Gate drive considerations for IGBT modules”, IEEE Transactions on Industry Applications, Vol. 31, No. 3., May/June 1995. The resistors Rg of the circuit 80 are located between the pre-driver and gates of the driven power devices (PM1, NM1) of the power stage to reduce switching di/dt of the circuit, but turn-off loss also increases. In addition, the circuit 80 introduces large gate propagation delay, which is not suitable for switching circuits with ultra short deadtime (<10 ns). The circuit 80 of FIG. 4 only decreases the effective Vds of the pre-driver, and uses large gate resistors, so that the effective Vds of the pre-driver continues to decrease when the drive current is small.

Instead of between the pre-driver drain and the gate of driven power devices of resistors Rg shown in the comparative circuit 80, the circuit 10 of FIG. 1 does not have resistors Rg. Instead, the circuit 10 in accordance with an embodiment of the invention comprises resistors (R1-R4) that are in series with the sources of the pre-driver 12 MOSFETs.

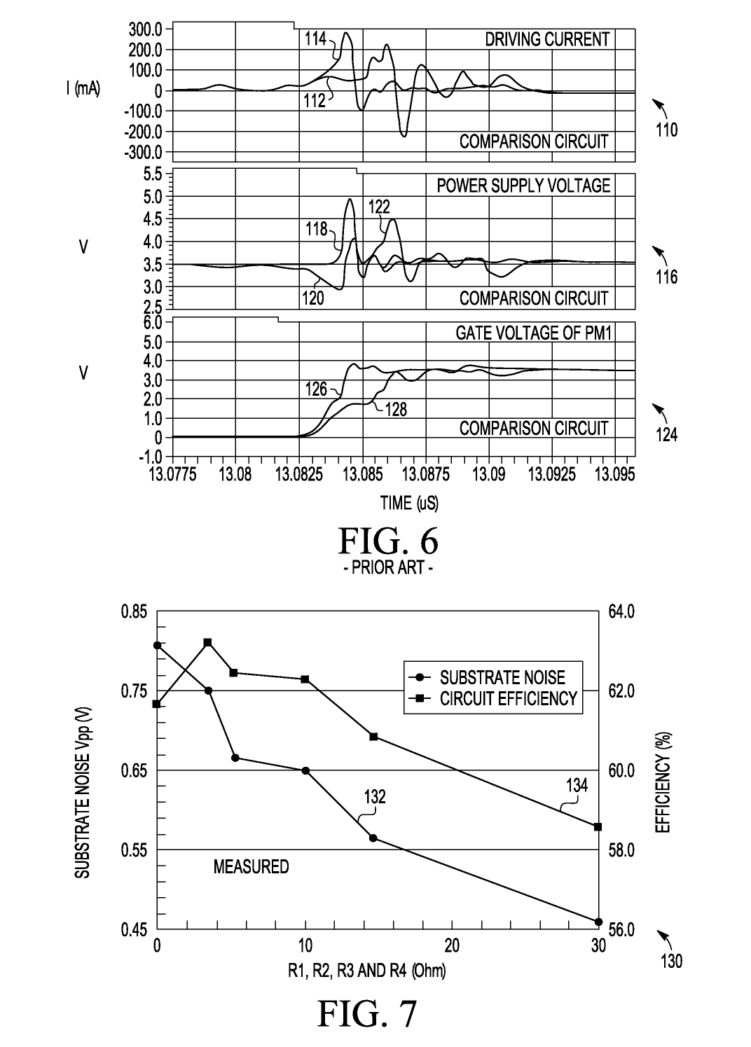

Simulated results of the two circuits 10 and 80 are shown and discussed to illustrate the advantages of embodiments of the invention. Simulated results for the circuit 10 are shown in FIGS. 2 and 3, while comparative results are shown in FIGS. 5 and 6.

FIGS. 5 and 6 show a comparison of the circuits 10 and 80. FIG. 5 is a graph 100 of simulated substrate noise and efficiency of the circuit 10 verses the comparative circuit 80. FIG. 6 shows graphs 110, 116, and 124 that chart the simulated drive current 110, power supply voltage 116 and gate voltage 124 at PM1 of the comparative circuit 80. The results of the comparative circuit 80 are shown by line 102, while the results of the circuit 10 are shown by line 104 in FIG. 5.

In FIG. 6, the results of the drive current, power supply voltage, and gate voltage of PM1 of the circuit 10 are shown by lines 114, 120, 126. In contrast, the results of the drive current, power supply voltage, and gate voltage of PM1 of the circuit 80 are shown by lines 112, 122, 128 respectively.

It is evident that the circuit 10 of FIG. 1 is more efficient and an improvement is made with respect to substrate noise. Additionally, the circuit 10 of FIG. 1 has a gate propagation delay that is shorter than the circuit 80 of FIG. 4.

Embodiments of the invention provide an improved result that is relatively simple to implement as the embodiment shown in FIG. 1 comprises R1-R4 resistors. The circuit 10 has been tested and implemented in practice. The test circuit is a 3.6V, 6.5 MHz buck converter based on 0.13 μm SMOS10W technology. The pre-driver 12 and control circuit 14 have been integrated on one chip. The control circuit 14 is a pulse width modulator (PWM) control circuit that is added into the test bench. Final chip size of the test circuit is 1.0 mm×1.1 mm. Parasitic resistors and capacitors of the circuit substrate are extracted from the layout by Cadence substrate extraction tool QRC, and the bondwire is modeled by series RL (L=0.41 nH, R=50 mΩ). The measured results are shown in the graph 130 of FIG. 7.

FIG. 7 shows a graph 130 of measured substrate noise and efficiency of the circuit 10 of FIG. 1 in accordance with an embodiment of the invention. The substrate noise graph is shown by line 132, and the circuit efficiency line is shown by line 134. As indicated above with respect to FIGS. 2 and 3, since the silicon area was limited during experimentation, which limited the actual size of the power device to about 75% smaller than usual, the efficiency is shown as being less than 70% in FIG. 7. The efficiency is higher and closer to 90% on full size power devices.

The circuit 10 is effective as substrate noise is decreased while circuit efficiency is maintained. The implementation of embodiments is compatible with current technology and may be easily integrated. As the additional resistors occupy relatively limited or small silicon area, the cost to implement embodiments of the invention is low.

It will be appreciated that other circuit configurations are possible than that shown in FIG. 1. The circuit shown in FIG. 1 is for just one type of circuit and embodiments of the invention are not limited to this specific configuration. For example the pre-driver circuit may be designed with more or fewer than four resistors R1, R2, R3 and R4, and more or fewer than NM2, NM3, PM2 and PM3. Embodiments of the invention may comprise more or fewer MOSFETs than the four MOSFET circuit design shown in FIG. 1.

While embodiments of the invention have been described and illustrated, it will be understood by those skilled in the technology concerned that many variations or modifications in details of design or construction may be made without departing from the present invention.

1. A pre-driver circuit for driving a power switching circuit, the power switching circuit having a power device of a power stage of the power switching circuit, the pre-driver circuit comprising:
a MOSFET having a source and a drain to drive with a drive current power devices of the power stage of the power switching device; and
a resistor in series with the source of the MOSFET to adjust the drive current.

2. The pre-driver circuit of claim 1, wherein the resistance of the resistor is selected to have a voltage across the resistor with the presence of the drive current that reduces the effective gate-source voltage (Vgs) and the drain-source voltage (Vds) of the MOSFET.

3. The pre-driver circuit of claim 1 comprising four MOSFET and a resistor in series with each source of the MOSFET to adjust the drive current.

4. The pre-driver circuit of claim 3, wherein the four MOSFET comprise two NMOS and two PMOS.

5. The pre-driver circuit of claim 4, wherein the pre-driver circuit forms part of a buck converter.

6. A power switching circuit, comprising:
a pre-driver circuit for driving the power switching circuit; and
a power stage having a power device, wherein the pre-driver circuit comprises:
a MOSFET having a source and a drain to drive with a drive current power devices of the power stage of the power switching device; and
a resistor in series with the source of the MOSFET to adjust the drive current.

7. The power switching circuit of claim 6, wherein the resistance of the resistor is selected to have a voltage across the resistor with the presence of the drive current to reduce the effective gate-source voltage (Vgs) and the drain-source voltage (Vds) of the MOSFET.

8. The power switching circuit of claim 6 comprising four MOSFET and a resistor in series with the source of the MOSFET to adjust the drive current.

9. The power switching circuit of claim 8, wherein the four MOSFET comprise two NMOS and two PMOS.

10. The power switching circuit of claim 9, wherein the pre-driver circuit forms part of a buck converter.

11. A method of driving a power switching circuit with a pre-driver circuit, the power switching circuit having a power device of a power stage of the power switching circuit, and the pre-driver circuit driving with a drive current the power device of the power stage of the power switching device, the method comprising the steps of:
providing a MOSFET in the pre-driver circuit having a source and a drain to drive with a drive current power devices of the power stage of the power switching device; and
adjusting the drive current of the MOSFET by selecting a resistor arranged in series with the source of the MOSFET.

12. The method of claim 11, wherein the resistance of the resistor is selected so that a voltage across the resistor caused by the presence of the drive current reduces the effective gate-source voltage (Vgs) and the drain-source voltage (Vds) of the MOSFET.

13. The method of claim 11, wherein providing a MOSFET comprises providing four MOSFET and wherein the resistor is arranged in series with the source of each MOSFET.

14. The method of claim 13, wherein selecting the four MOSFET of the pre-driver circuit comprises two NMOS and two PMOS.

15. The method of claim 14, wherein the pre-driver circuit is part of a buck converter.
